(19) United States
(12) Patent Application Publication
(10) Pub. No.: US 2005/0152220 A1
(43) Pub. Date: Jul. 14, 2005

(54) Seismic data processing

(76) Inventors: Alexander Kritski, Trondheim (NO); Lasse Amundsen, Trondheim (NO)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/030,264

(22) Filed: Jan. 6, 2005

(30) Foreign Application Priority Data
Jan. 9, 2004 (GB) 0400424.8

(51) Int. Cl. G01V 1/36

(52) U.S. Cl. 367/38

(57) ABSTRACT

A method is provided for processing seismic data, such as Vertical Seismic Profiling data obtained from a borehole having an interface between a borehole fluid and a rock formation. The method applies a transform to a pair of seismic data records measured at the interface to generate a pair of wavelet fields, and performs a correlation between at least parts of the pair of wavelet fields in order to provide an estimate of the physical characteristics of the formation, and in particular the shear wave velocity.

### RELATED APPLICATION

The present application claims priority to GB 0400424.8 filed Jan. 9, 2004.

### TECHNICAL FIELD

The present invention relates to a method of processing seismic data. Such processing may be used in estimating shear wave velocities along an interface, and a particular example of this is in the analysis of vertical seismic profiling data.

### BACKGROUND OF THE INVENTION

Vertical seismic profiling (VSP) surveys are a valuable diagnostic tool in determining the properties of geological formations surrounding a borehole. In such surveys, a commonly measured acoustic parameter is the velocity of compressional waves. The compressional wave is the fastest in the formation, non-dispersive and the easiest type of wave to identify and measure. However, the most relevant elastic parameters of the geological formations can only be obtained from the shear velocities since the shear modulus is directly associated with the shear velocity. Direct determination of the shear velocity from the time of arrival data is very difficult or impossible because shear wave arrivals are usually obscured by other compressional wave arrivals, both reflected and refracted. The compressional wave arrival signals have a considerably higher amplitude than the shear wave signals, which are hard to recover.

A typical borehole from which VSP data is obtained is illustrated in FIG. 1. A channel 1 is drilled into the ground, typically vertically, although in reality it may be slightly off-vertical. The channel 1 is drilled into a rock formation 2, and contains a region of fluid 3 which lies between a tool and the rock formation. A number of sensors such as 4 are connected to a multi-core cable and lie equally spaced along the length of the borehole 1. Seismic waves propagate in the rock formation 2 surrounding the borehole and are recorded on the array of sensors, such as hydrophones, geophones or accelerometers.

Two main wave types propagate in the fluid-filled borehole. Firstly, there are ‘P’ and ‘S’ waves refracted along the interface between the fluid 4 and the formation 2 and/or reflected from interfaces and possible boundaries within the formation, e.g. fractures.

Secondly, there are so-called ‘guided waves’, propagating along interfaces. The first type of guided wave is the Scholte wave, which is an interface wave that propagates along fluid-solid boundaries. In exploration geophysics, this type of wave is known as a Stoneley wave. Surface waves propagate along boundaries with velocities close to the shear velocities of surrounding formations. Amplitudes of surface waves decay approximately exponentially on both sides of the interface: in the case of a borehole, between the fluid and the formation. For depth or distance dependent shear moduli, both the phase and group velocities of the surface waves are subject to frequency dependent dispersion.

A further category of guided waves includes the reflected waves, normal modes and pseudo-Rayleigh waves. They have phase velocities bounded from above by the ‘S’ wave velocity of the formation and from below by the ‘P’ wave velocity of the fluid. Their amplitudes also decay exponentially in the rock formation away from the fluid-rock interface. However, their amplitudes within the fluid are oscillatory.

Scholte waves are very well known in seismo-acoustics where they are used to estimate physical properties of marine sediments. The shear wave velocities in ‘soft’ marine sediments are much smaller than the compressional wave velocities. The shear velocity has a very large gradient close to the ocean floor, leading to strong coupling of the compressional and shear waves in ‘soft’ sediments. Elastic waves in ‘soft’ sediment comprise waves propagating with velocities close to the compressional velocity and waves propagating with velocities on the order of the shear velocity. The first type of slow shear waves can cause surface waves or the Scholte waves.

Theoretical and experimental studies of elastic wave propagation both in the borehole environment and in marine sediments prove that the dispersion of the surface waves can provide an insight into the geoacoustic properties of the formation that are difficult to measure by other means. Geoacoustic models of the formation layers, along with any possible fractures, offer the potential to predict physical properties of the formation and fractures.

In studying wave propagation in boreholes, it is necessary to accurately model both compressional and dynamic shear properties of the formation over a significant depth to calculate meaningful values of transmission loss as a function of frequency and range. This is a particularly difficult task because the formations are usually quite inhomogeneous near the borehole boundaries. The inhomogeneities result partly from the history of the geological depositions, and partly from the effects of geostatic stress on the porous medium.

U.S. Pat. No. 4,575,830 discloses a method for estimating shear wave velocities in regions where such velocities are otherwise difficult to measure. A Stonely interface wave arrival is identified at a number of sensors, and the Fourier transform of each arrival taken. The difference in phase of the arrivals is related to the phase velocity and subsequently the shear modulus is estimated. The shear modulus is then used to estimate the shear velocity. The one-dimensional transform applied in this method, along with the subsequent “scanning” for peaks in the frequency domain, render this a rather inaccurate method.

Very often in applied geophysics, surface waves are also called ‘tube waves’. In order to study how surface waves in general can contribute to shear properties, the term ‘tube waves’ is used herein to generalize all kinds of surface waves that might propagate in the formation, regardless of their physical nature.

### SUMMARY OF THE INVENTION

According to a first aspect of the invention, there is provided a method as defined in the appended claim 1.

Further aspects and embodiments of the invention are defined in the other appended claims.

It is thus possible to provide a technique which permits improved determination of shear wave velocity in VSP data through complex analysis of seismic signals in the space-time domain to measure and observe surface waves. There is also provided improved inversion of acoustical parameters, in particular determining the group and phase velocities from measurements of observed tube and shear waves.

The proposed technique may also be used as a tool for studying the complexity of waves propagating in a formation, primarily to distinguish between different types of guided waves, particularly pure tube waves and pseudo-Rayleigh waves, whose nature is not well understood.

For a better understanding of the present invention and in order to show how the same may be carried into effect, preferred embodiments of the invention will now be described, by way of example, with reference to the accompanying drawings.

### BRIEF SUMMARY OF THE DRAWINGS

FIG. 1 illustrates apparatus for recording seismic data in a borehole;

FIG. 2 illustrates harmonic wave propagation in a borehole;

FIGS. 3 and 4 are flow diagrams illustrating a method constituting an embodiment of the present invention;

FIGS. 5 and 6 illustrate the results of a wavelet transform in accordance with an embodiment of the present invention;

FIG. 7 illustrates the results of cross-correlation in accordance with an embodiment of the present invention;

FIG. 8 illustrates the results of shear velocity determination in accordance with an embodiment of the present invention;

FIG. 9 illustrates the amplitudes of phase velocities obtained in accordance with an embodiment of the present invention; and

FIG. 10 is a block schematic diagram of an apparatus for performing the method of FIGS. 3 and 4.

### DETAILED DESCRIPTION OF THE INVENTION

The technique disclosed herein allows for the estimation of shear velocities in situations where such velocities are difficult or impossible to measure using known direct methods, e.g. when shear energy transmission is attenuated or shear waves do not propagate under certain conditions, or when shear wave arrivals are obscured by other type wave arrivals, both reflected and refracted. The proposed technique comprises measuring tube wave characteristics to determine shear wave velocities. Dispersive characteristics of surface wave velocities are directly linked into the shear moduli and shear velocities. The technique allows direct measurement of phase velocities of the tube waves in the frequency range from one to several hundred Hertz.

The present technique requires a series of seismic data records, as typically measured along a borehole. One example of such records comprises standard VSP time series records acquired from a vertical borehole. A wavelet transform is applied to each record, allowing decomposition of the signals in a two-dimensional time-frequency plane (wavelet field), from which the tube wave dispersion curves can be obtained, separated and studied. Cross-correlation is applied to the wavelet fields for pairs of records. From the phase field of the wavelet cross-correlation function, the inversion of phase-velocity dispersion can be evaluated over a narrow frequency range where the signal is strong and the phase differences are easily determined. By analyzing the distribution of maxima and minima of phase differences in the phase field of the wavelet cross-correlation, the phase velocities of the tube waves can be measured at several frequencies. Wavelet cross-correlation of two signals from closely spaced receivers directly determines the phase velocity, which would be an average for the depth interval between the two receivers. By applying the wavelet cross-correlation to different pairs of signals, the phase velocity for different depth levels can be derived. The obtained phase velocities can be then directly inverted into shear velocities using existing inversion relationships. The resolution of the method is limited only by the depth interval between adjacent sensors.

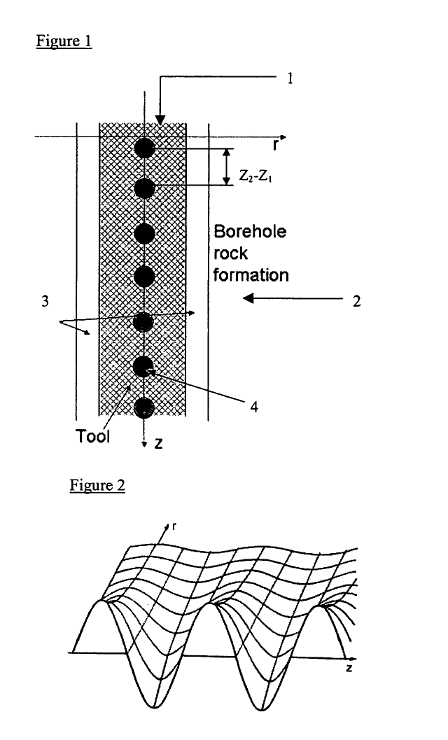

The propagation of harmonic tube waves along a fluid-solid interface is illustrated in FIG. 2, where the z axis represents depth. The tube wave propagates in the z direction, the direction of the interface, and decays exponentially radially away from the interface in the r direction. For vertically and horizontally polarized tube waves the acoustic pressure can be generally defined as:
P=P₀exp(iξz−ar−−iωt) (1)
where ξ and a are the z and r direction wave-numbers, respectively. This is a solution that satisfies the wave equation for elastic media. The quantity P₀ is the initial amplitude, and ω is the angular frequency.

The phase velocity is defined as:

$${V}_{phase} = \frac{ω}{ξ} .$$

The group velocity is

$${V}_{group} = \frac{\partial ω}{\partial ξ} = {V}_{phase} ( {V}_{phase} - \frac{ω}{{V}_{phase}} \frac{\partial {V}_{phase}}{\partial ω} ) .$$

For slow elastic waves in half-space at a solid-solid interface with constant density ρ and a power-law depth dependence of the shear modulus of

$$μ = ρ {{V}_{shear}^{2} ( \frac{z}{l} )}^{2 v} ,$$

where 0<v<1, Vₛₕₑₐᵣ is the shear modulus, and l is a depth level, the vertically and horizontally polarized tube waves have a phase velocity of:

$${V}_{n} = \frac{2 {V}_{shear}^{2}}{ω l} n and {V}_{n} = \frac{2 {V}_{shear}^{2}}{ω l} ( n - 1 / 2 ) for n = 1 , 2 , 3 , …$$

The tube wave is a combination of propagation along the interface, where the phase is moving in the z direction, and phase oscillations (modes) in the r direction where amplitude is rapidly decaying with r. Propagation fronts are defined as planes along which z is a constant, i.e. at a given depth. Based on the depth-dependent shear properties of the formation, the vertical and horizontal displacements in tube waves have different shapes with respect to depth, corresponding to different modes.

Two general tube waves Pₓ and P_{y}, defined as superpositions of harmonic waves where each wave is defined in the form of Equation (1) above are considered:

$${P}_{x} ( r , z , t ) = {\sum }_{j = 1}^{n} Bo exp ( {ⅈξ}_{xj} {z}_{x} - {a}_{j}^{x} r - ⅈ {w}_{j} t + {θ}_{j}^{x} ( r , z , t ) ) \\ {P}_{y} ( r , z , t ) = {\sum }_{k = 1}^{n} Ao exp ( {ⅈξ}_{yk} {z}_{y} - {a}_{k}^{y} r - ⅈ {w}_{k} t + {θ}_{k}^{y} ( r , z , t ) ) , \qquad ( 2 )$$

where indices x and y correspond to the two tube waves.

These tube waves can be interpreted as the results of measurements at two different locations (receivers) along the depth axis. A phase component θ accounts for a possible initial phase shift between two signals and/or a random phase shift (i.e. noise) that might have been collected along the propagation path between the two receivers during the time of measurements due to factors other than propagation. Generally, θ is a function of z, r and t, such that θ=θ(r, z, t).

Application of a wavelet transform to these two waves unfolds them into their two-dimensional time-frequency planes:

$$WP ( b , a ) = \frac{1}{2 π} {\int }_{- ∞}^{∞} P ( r , z , t ) ψ ( \frac{t - b}{a} ) ⅆ t , \qquad ( 3 )$$

where, WPₓ(b,a) defines a continuous wavelet transform of signal Pₓ at scale a and time b relative to a real integratable analyzing wavelet function ψ(t).

The wavelet transforms WPₓ(b, a) and WP_{y}(b, a) can then be used to find a cross-correlation function called the wavelet cross-correlation function WC_{xy}(a,τ), often used in marine sediments studies:

$${WC}_{xy} ( a , τ ) = {lim}_{T -> ∞} \frac{1}{T} {\int }_{- 2 / T}^{2 / T} \overline{{WP}_{x} ( b , a )} {WP}_{y} ( b + τ , a ) ⅆ b \qquad ( 4 )$$

where τ is a time shift between the signals when the cross-correlation is applied, T is the period for which the cross-correlation is applied. For given time signals, T is defined as the duration of the signal. The upper bar on WPₓ(b,a) indicates its complex conjugate.

Although the technique described herein refers to a wavelet transform, it will be appreciated that any transform which allows decomposition of the one-dimensional signal over a two-dimensional plane in domains that are essential for the original signal may be used. Such transforms would map, for example, into the period-velocity, wavenumber-frequency, or period-spatial domains. The two-dimensional fields of scales into which the seismic data are transformed characterise the propagation properties of the seismic data.

From Equation (4) the amplitudes of the wavelet cross-correlation function may be determined, which gives the strength of the cross-correlation. The area where the cross-correlation signal is strong, and also the phase differences, can be determined.

Although the technique described herein refers to a cross-correlation, it will be appreciated that other correlation methods may be used to achieve the same effect. These can include, for example, cross-multiplication, sum or difference, or bispectral correlation. A correlation of transformed fields can be introduced in different domains simultaneously.

The phase of the wavelet cross-correlation analysis is used to obtain the phase differences between two wavelet transforms. Using Equations (2) to (4) the wavelet cross-correlation of two signals Pₓ and P_{y} can be expressed as:

$${WC}_{xy} = {\sum }_{j}^{n} {\sum }_{k}^{n} ψ ( {ω}_{j} ) \overline{ψ ( {ω}_{k} )} exp ( ⅈτ ( {ω}_{j} - {ω}_{k} ) exp ( ⅈ z ( {ξ}_{j}^{x} - {ξ}_{k}^{y} ) ) exp ( r ( {a}_{k}^{x} - {a}_{j}^{y} ) ) * exp ( {θ}_{j}^{x} ( r , z ) - {θ}_{k}^{y} ( r , z ) ) * {lim}_{T -> ∞} \frac{1}{T} {\int }_{- T / 2}^{T / 2} exp ( ⅈ ( {ω}_{j} - {ω}_{k} ) b ) exp ( {θ}_{j}^{x} ( t ) - {θ}_{k}^{y} ( b ) ) ) ⅆ b \qquad ( 5 )$$

It can be seen that WC_{xy}≠0 only when ωⱼ=ωₖ. Therefore, when ωⱼ=ωₖ, Equation (5) can be reduced to:

$${WC}_{xy} ( a , τ ) = {\sum }_{j}^{n} {\vert ψ ( {ω}_{j} ) \vert}^{2} exp \text{(} {ⅈω}_{j} τ + ⅈ z ( {ξ}_{j}^{x} - {ξ}_{j}^{y} ) + r ( {a}_{j}^{x} - {a}_{j}^{y} ) + ( {θ}_{j}^{x} ( x , z ) - {θ}_{j}^{y} ( r , z ) ) * {lim}_{T -> ∞} \frac{1}{T} {\int }_{- T / 2}^{T / 2} exp ( {θ}_{j}^{x} - {θ}_{j}^{y} ) ⅆ b \qquad ( 6 )$$

The last integral in Equation (6) gives a value of one when averaging over a sufficiently long time such that the random phase change is zero.

The phase of the wavelet cross-correlation function is then:

$$\begin{matrix}Ξ {WC}_{xy} = a tan ( Im ( {WC}_{xy} ) / Re ( {WC}_{xy} ) \\ = a tan [ \frac{{\sum }_{j}^{n} {\vert ψ ( {ω}_{j} ) \vert}^{2} sin ( {ω}_{j} τ + z ( {ξ}_{j}^{x} - {ξ}_{j}^{y} ) + ⅈ r ( {a}_{j}^{x} - {a}_{j}^{y} ) + ( {θ}_{j}^{x} - {θ}_{j}^{y} ) )}{{\sum }_{j}^{n} {\vert ψ ( {ω}_{j} ) \vert}^{2} cos ( {ω}_{j} τ + z ( {ξ}_{j}^{x} - {ξ}_{j}^{y} ) + ⅈ r ( {a}_{j}^{x} - {a}_{j}^{y} ) + ( {θ}_{j}^{x} - {θ}_{j}^{y} ) )} ] \\ = a tan [ \frac{{\sum }_{j}^{n} sin ( {ω}_{j} τ + z ( {ξ}_{j}^{x} - {ξ}_{j}^{y} ) + ⅈ r ( {a}_{j}^{x} - {a}_{j}^{y} ) + ( {θ}_{j}^{x} - {θ}_{j}^{y} ) )}{{\sum }_{j}^{n} cos ( {ω}_{j} τ + z ( {ξ}_{j}^{x} - {ξ}_{j}^{y} ) + ⅈ r ( {a}_{j}^{x} - {a}_{j}^{y} ) + ( {θ}_{j}^{x} - {θ}_{j}^{y} ) )} ]\end{matrix} \\ which simplifies to \text{:} \\ Ξ {WC}_{xy} = {\sum }_{j}^{n} ( {ω}_{j} τ + z ( {ξ}_{j}^{x} - {ξ}_{j}^{y} ) + ⅈ r ( {a}_{j}^{x} - {a}_{j}^{y} ) + ( {θ}_{j}^{x} ( x , z ) - {θ}_{j}^{y} ( r , z ) ) ) . \qquad ( 7 )$$

Σωⱼτ is a time delay between two signals. The quantity τ describes a difference in phases between two signals, caused by the time delay. For a given frequency ωⱼ we can obtain a phase difference as a function of time delay between two wavelet transform signals. When τ=0 the phase shift between two signals is caused only by the time it takes for the wave to travel between the two receivers. In other words it gives the group velocity, since the distance between receivers is known. Thus, this is a ‘time-phase’.

The second phase component, Θ(r, z), is defined in the r-z plane by:

$$Θ ( r , z ) = {\sum }_{j}^{n} ( z ( {ξ}_{j}^{x} - {ξ}_{j}^{y} ) + ir ( {a}_{j}^{x} - {a}_{j}^{y} ) ) ,$$

and represents a phase shift between the two wavelet transform coefficients as a function of distance and depth and describes the phase variations that might have been collected by tube waves whilst travelling from one receiver to the next.

Wave-numbers in the z and r directions generally keep their indexes (j and a, respectively) as no integration has been applied over r and z. For simplicity, at this stage, as there is no phase motion in the r direction, only Θ(r, z)=Θ(z) will be considered.

Two seismic data measurements are taken at two different locations in depth, z₁ and z₂, defining a depth interval z₂−z₁=ΔZ. Taking into account that the phase velocity for the tube wave is

$${V}_{p} = \frac{ω}{ξ}$$

and that ωⱼ=ωₖ, the phase component can be re-written as:

$$Θ ( z ) = {\sum }_{j}^{n} [ {z}_{1} {ξ}_{j}^{1} - {z}_{2} {ξ}_{j}^{2} ] = {\sum }_{j}^{n} [ {ω}_{j} ( \frac{{z}_{1}}{{V}_{{p1}_{j}}} - \frac{{z}_{2}}{{V}_{{p2}_{j}}} ) ] , \qquad ( 8 )$$

where Vp₁ and Vp₂ are phase velocities at receivers 1 and 2, and ξⱼ¹, ξₖ² are wave-numbers (in z) for the two waves. The term ωⱼ is the frequency index that scans through the frequency range.

Thus, the phase field of the wavelet cross-correlation identifies the difference in phase velocities between two measurements for the number of frequencies defined by the wavelet transform. The sum

$${\sum }_{j}^{n} ( \frac{{z}_{1}}{{V}_{{p1}_{j}}} - \frac{{z}_{2}}{{V}_{{p2}_{j}}} )$$

defines a commutative effect of phase shift which is, in fact, the average of all spatial variations in phase that the signal from receiver ‘2’ could have experienced in comparison with the signal from receiver ‘1’ for frequencies ωⱼ. The smaller the depth interval, the better the spatial resolution that may be achieved.

Phase variations will contain all the information that the tube waves could accumulate whilst propagating along an interface whose depth-dependent shear properties might be different in the regions of the two receivers. The propagation path may also include reflections from interfaces (fractures) in the formation which can be identified by a change of the phase difference of ±π or ±π/2 depending of the type of the boundaries (hard or soft).

From Equation (8), the full phase in terms of delay and spatial shift can be expressed as:

$$Ξ {WC}_{xy} = {\sum }_{j}^{n} ( ( {ω}_{j} τ ) + {ω}_{j} ( \frac{{z}_{1}}{{V}_{{p1}_{j}}} - \frac{{z}_{2}}{{V}_{{p2}_{j}}} ) \\ = {\sum }_{j}^{n} [ {ω}_{j} ( τ + ( \frac{{z}_{1}}{{V}_{{p1}_{j}}} - \frac{{z}_{2}}{{V}_{{p2}_{j}}} ) ) ] , \qquad ( 9 )$$

ΞWC_{xy} describing the phase difference between two signals at two different locations for a given time delay τ and frequency ωⱼ. This may be used to identify a phase change, caused by changing phase velocities between location points, of

$$( \frac{{z}_{1}}{{V}_{{p1}_{j}}} - \frac{{z}_{2}}{{V}_{{p2}_{j}}} ) .$$

When Vp₁=Vp₂ there are no changes in physical properties between receivers. The time shift in the phase of the wavelet cross-correlation function is then

$$Ξ {WC}_{xy} = {\sum }_{j}^{n} ( {ω}_{j} τ ) .$$

Alternatively, assuming that receivers 1 and 2 are spaced closely together, such that the shear properties of the formation at depths 1 and 2 are similar, Equation (9) can be used to estimate the phase velocity, which in this case would be an average velocity in the depth range: z₁−z₂, as:

$$Ξ {WC}_{xy} = {\sum }_{j}^{n} [ {ω}_{j} ( τ + ( {z}_{1} - {z}_{2} ) ( \frac{1}{{V}_{p}} ) ] . \qquad ( 10 )$$

Thus the cross-correlation phase can be inverted directly to give the phase velocity for the closely spaced receivers.

The shear velocity may be estimated from the obtained phase velocities using an empirical relationship, such as νₛₕₑₐᵣ˜1.1×νₚₕₐₛₑ.

An advantage of using the wavelet cross-correlation function is that its phase gives a straightforward measure of phase velocities without additional processing, for all frequencies of interest. Using the cross-correlation data of other frequencies could possibly improve the accuracy of the shear curve. The phase of the wavelet cross-correlation field illuminates the entire velocity structure that particular tube wave signal can contain. In estimating the shear velocity profile, only a limited part of the spectra at a single time-delay value which would correspond to the tube waves is used. However, the remaining spectrum can also be used to gain information about the formation.

Wavelet transformation of the tube wave helps to distinguish the narrow band zones where the signal is strong; these zones represent different modes of tube waves. Having identified these narrow zones, the phase velocity analysis can be performed within them. After application of the wavelet transform and selection of a particular dispersion mode, the spectrum consists of a narrow frequency band centered on some low frequency, since tube waves are a very low frequency process, i.e. the signal is demodulated for low tube wave frequencies. High carrier frequencies corresponding to compressional waves are removed. This spectrum translation does not lose information about the tube waves, neither amplitudes nor phases, and has the advantage that the translated signal oscillates much more slowly and undergoes a uniform phase shift.

Equation (9) presents a field of phase differences between two tube waves measured at two receivers on the borehole-formation interface for given frequencies. This allows observation and measurement of these phase differences in conditions of dispersion, characterising tube waves in terms of phase and group velocity dispersions. Generally, there are two components: time phase and spatial phase. The time component yields the group velocities. The spatial component provides the spatial variations in the phase velocity of the tube waves. These variations that may occur between the two receivers can be used in the inversion to obtain the phase velocities. Thus, the group and phase velocities can be inverted from the wavelet cross-correlation function directly for each given frequency.

The wavelet cross-correlation coefficients can be used in the separation of the tube wave modes and detection of the group velocity dispersion curve over as wide a frequency band as possible, to cover all possible tube waves. Then, from the phase field of the wavelet cross-correlation function, the inversion of phase velocity dispersion can be evaluated over a narrow frequency range where the signal is strong and the phase differences are easily determined. Wavelet cross-correlation of two wave fields from closely spaced receivers z₁ and z₂ can be inverted directly to obtain the phase velocity as shown in Equation (10). Finally, by applying wavelet cross-correlation to different pairs of VSP records, the phase velocity values at different depth levels can be derived. The obtained phase velocities can be then inverted into shear velocities using existing inversion relationships.

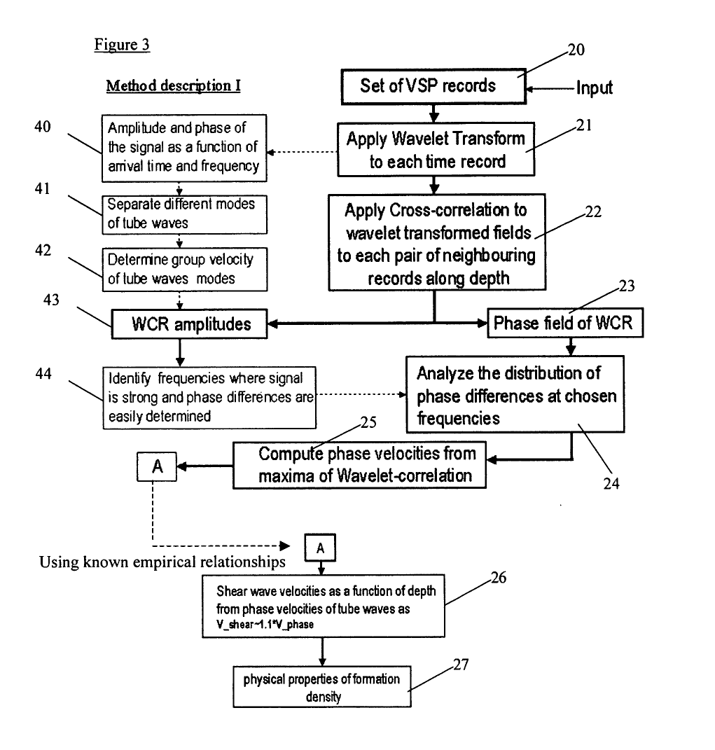

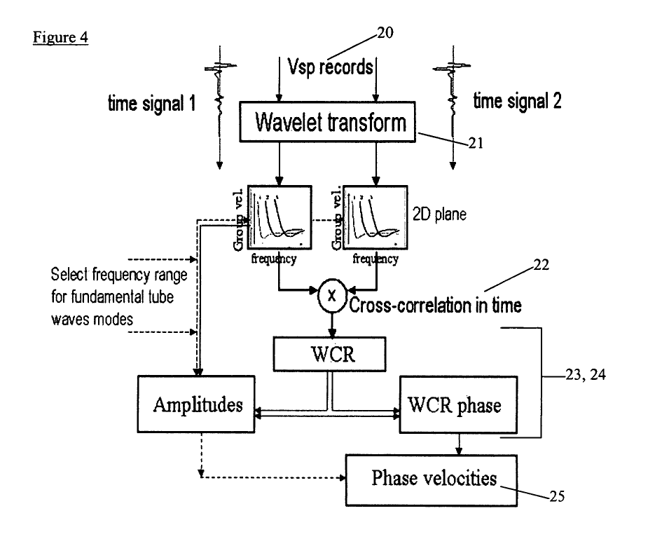

The technique of the above embodiment is illustrated in the flow diagrams of FIGS. 3 and 4, in which like numerals represent like processes. The VSP records from a pair of receivers within a borehole are entered at step 20, and at step 21 a wavelet transform is applied to each record. The transform provides a wavelet field in the time-frequency plane for each record, having the amplitude and phase of the signal as a function of arrival time and frequency (step 40), from which the tube wave dispersion curves are extracted (step 41) after removal of the higher frequencies. The group velocity may also be determined from the dispersion curves (step 42). A cross-correlation is applied to each pair of wavelet-transformed fields at step 22 to provide a phase field (step 23) with corresponding amplitudes (step 43) which is analysed at step 24, having identified frequencies at which the signal is strong and phase differences are easily determined (step 44), and the maxima of which are used in step 25 to compute the phase velocities. Having extracted regions of strong signal in the phase field, shear wave velocities as a function of depth may be obtained (step 26) and inversion of the phase field allows estimation of physical properties of the formation (step 27).

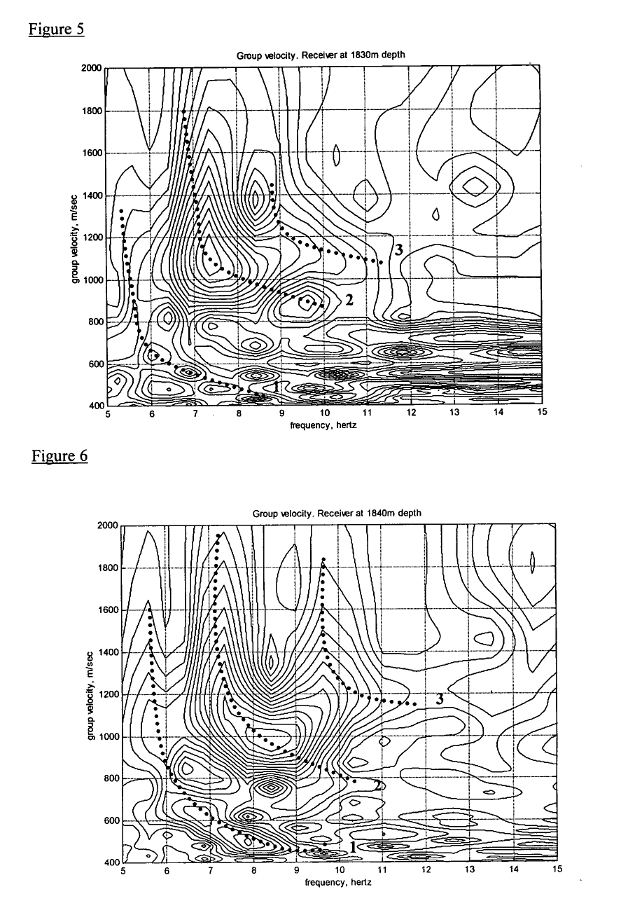

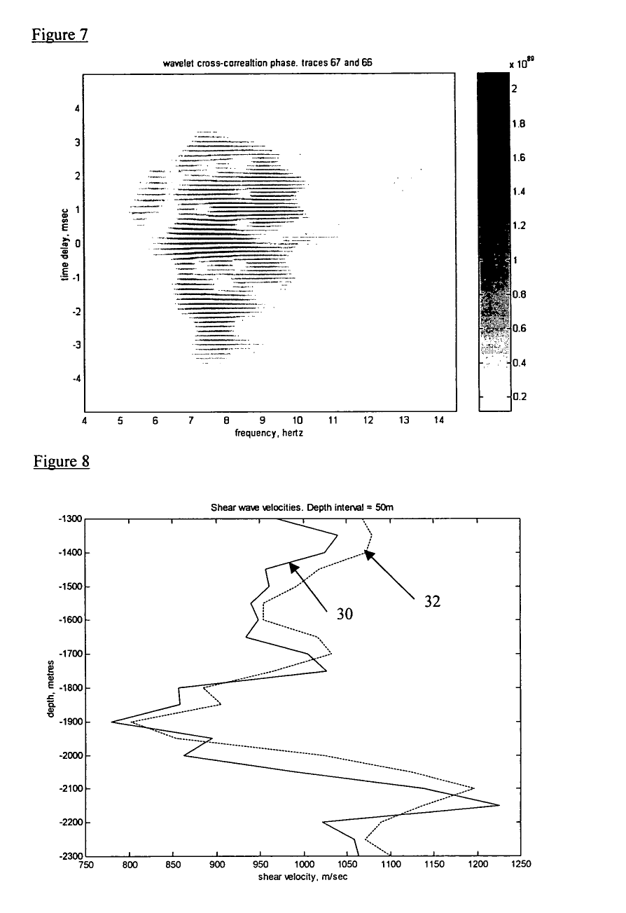

FIGS. 5 and 6 show the result of the wavelet transform for two experimental VSP records, respectively. The distance between the two receivers is 10 m. Both Figures show three modes, indicated by the dotted lines, which may be interpreted as a fundamental tube wave and two of its higher frequency modes. FIG. 7 shows the phase field of the wavelet cross-correlation between the two records. The phase velocities are determined from the phase field of the wavelet cross-correlation function over a narrow frequency band (7-9 Hz) where the signal is strong and phase differences are easily determined. The shear velocity curve 30 illustrated in FIG. 8 is based on the wavelet cross-correlation calculation for a 100 m-depth interval only, using Equation (10). The VSP log curve 32, also shown in FIG. 8, was sampled at the same depth rate. The calculations show a reasonable fit to the VSP shear profile. FIG. 9 shows the amplitudes of all of the phase velocities of tube waves calculated from the wavelet cross-correlation function and includes not only low-speed tube waves but also velocities at magnitudes of 2000 m/sec, which are interpreted as being compressional waves.

The data processing methods described above may be embodied in a program for controlling a computer to perform the technique. The program may be stored on a storage medium, for example hard or floppy discs, CD or DVD-recordable media or flash memory storage products. The program may also be transmitted across a computer network, for example the Internet or a group of computers connected together in a LAN.

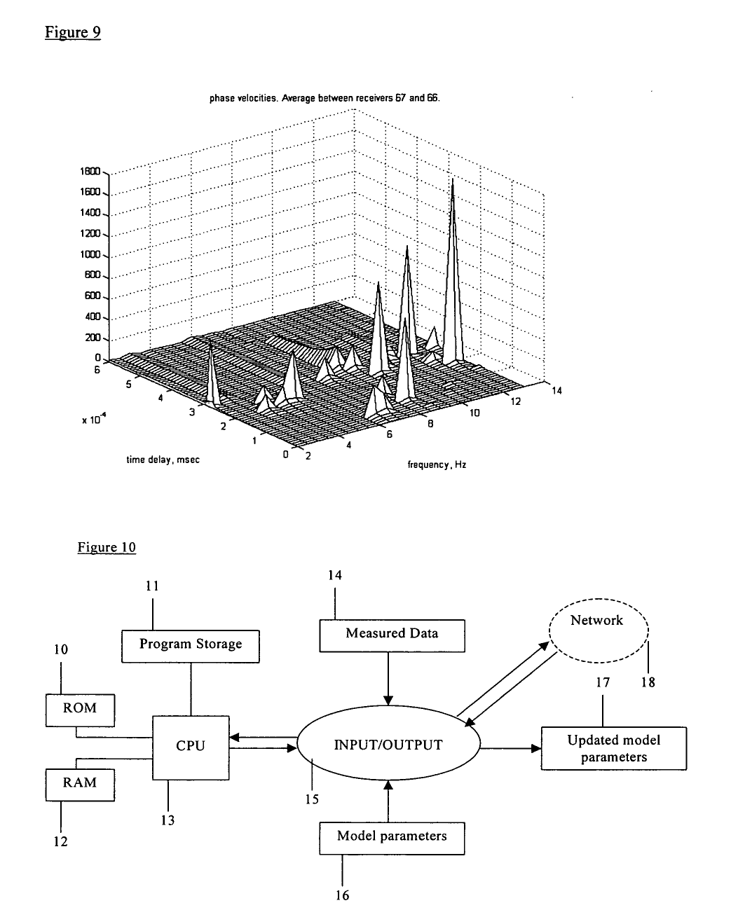

The schematic diagram of FIG. 10 illustrates a central processing unit (CPU) 13 connected to a read-only memory (ROM) 10 and a random access memory (RAM) 12. The CPU is provided with measured data 14 and model parameters 16 via an input/output mechanism 15. The CPU then performs the inversion on the provided data in accordance with the instructions provided by the program storage (11) (which may be a part of the ROM 10) and provides the output, i.e. the updated model parameters and uncertainties 17, via the input/output mechanism 15. The program itself, or any of the inputs and/or outputs to the system may be provided or transmitted to/from a communications network 18, which may be, for example, the Internet.

1. A method of processing seismic data, the method comprising:
applying a transform to a pair of seismic data records to obtain a pair of two-dimensional fields; and
performing a cross-correlation between at least parts of the pair of the two-dimensional fields.

2. A method as claimed in claim 1, wherein the seismic data records of the pair are temporally adjacent records.

3. A method as claimed in claim 1, wherein the seismic data records comprise records of tube waves, pseudo-Rayleigh waves, guided waves, or surface waves.

4. A method as claimed in claim 1, wherein the seismic data records are generated at an interface upon which surface waves can be generated.

5. A method as claimed in claim 1, wherein the seismic data records are obtained from a formation-fluid interface.

6. A method as claimed in claim 5, wherein the seismic data records are obtained from a formation-liquid interface.

7. A method as claimed in claim 1, wherein the seismic data records are obtained from a formation-solid interface.

8. A method as claimed in claim 1, wherein the seismic data records are obtained from a formation-borehole interface.

9. A method as claimed in claim 1, wherein the seismic data records are obtained from a borehole.

10. A method as claimed in claim 1, wherein the seismic data records are vertical seismic profiling records.

11. A method as claimed in claim 1, wherein the seismic data records are obtained using any combination of hydrophones, geophones, and accelerometers.

12. A method as claimed in claim 1, wherein the transform decomposes the one-dimensional seismic data over a two-dimensional plane in domains which are essential to the original signal.

13. A method as claimed in claim 12, wherein the transform is a wavelet transform.

14. A method as claimed in claim 12, wherein the transform transforms into the time-frequency domain.

15. A method as claimed in claim 1, wherein the transform is applied to different pairs of seismic data records.

16. A method as claimed in claim 15, wherein the different pairs are different temporally adjacent pairs.

17. A method as claimed in claim 1, comprising selecting only a part of the two-dimensional field generated by the transform for the correlation.

18. A method as claimed in claim 17, wherein the selection is made on the basis of the part containing a signal representing a mode of a tube wave.

19. A method as claimed in claim 17, wherein the selection is made on the basis of signal strength in the two-dimensional field.

20. A method as claimed in claim 17, wherein the selection is made on the basis of frequency.

21. A method as claimed in claim 1, wherein a correlation of transformed fields can be implemented in different domains simultaneously.

22. A method as claimed in claim 1, further comprising the step of obtaining a phase difference field from the correlation.

23. A method as claimed in claim 22, wherein the phase difference field can be expressed as
$$Ξ {WC}_{xy} = {\sum }_{j}^{n} ( ( {ω}_{j} τ ) + {ω}_{j} ( \frac{{z}_{1}}{{V}_{{p1}_{j}}} - \frac{{z}_{2}}{{V}_{{p2}_{j}}} ) \\ = {\sum }_{j}^{n} [ {ω}_{j} ( τ + ( \frac{{z}_{1}}{{V}_{{p1}_{j}}} - \frac{{z}_{2}}{{V}_{{p2}_{j}}} ) ) ] ,$$
where ω is an angular frequency, τ is a time delay between the data records, z is the depth of the data records, V is a phase velocity, and the indices 1 and 2 refer to the first and second records within the pair, respectively.

24. A method as claimed in claim 22, wherein the spatial phase is used to derive the phase velocity of seismic waves.

25. A method as claimed in claim 22, wherein the temporal phase is used to derive the group velocity of seismic waves.

26. A method as claimed in claim 22, further comprising the step of inverting the phase difference field to derive the shear wave velocity as a function of depth.

27. A method as claimed in claim 26, wherein the shear wave velocity is derived from the phase velocity using a known empirical relationship.

28. A program for controlling a computer to perform a method as claimed in claim 1.

29. A program as claimed in claim 28 stored on a storage medium.

30. Transmission of a program as claimed in claim 28 across a communications network.

31. A computer programmed to perform a method as claimed in claim 1.

32. An apparatus for processing seismic data, the apparatus comprising:
means for applying a transform to a pair of seismic data records measured at an interface to obtain a pair of wavelet fields; and
means for performing a cross-correlation between at least parts of the pair of wavelet fields.
